(19) United States
(12) Patent Application Publication
(10) Pub. No.: US 2025/0306567 A1
(43) Pub. Date: Oct. 2, 2025

(54) GENERATIVE ARTIFICIAL INTELLIGENCE CODE BLOCK SELECTOR AND CODEBASE UPDATING SYSTEM

(71) Applicant: Rockwell Automation Technologies, Inc., Mayfield Heights, OH (US)

(72) Inventors: Michael J. Anthony, Milwaukee, WI (US); Jonathan A. Mills, Mayfield Heights, OH (US); David C. Mazur, Grafton, WI (US); Patrick E. Ozimek, Elm Grove, WI (US); Eugene Mourzine, Twinsburg, OH (US)

(21) Appl. No.: 18/622,082

(22) Filed: Mar. 29, 2024

(51) Int. Cl. G05B 19/4155; G05B 19/408; G06F 11/36

(52) U.S. Cl. CPC G05B 19/4155; G05B 19/4083; G06F 11/3698

(57) ABSTRACT

Intelligent code block selection and codebase updating using generative AI is disclosed herein. A user may request a code block for performing a task based on a given quality parameter (e.g., most energy efficient, fastest, or the like). The system may select an AI model for evaluating code blocks to meet the quality parameter. The system may identify code blocks for evaluation and execute each code block in an isolated testing environment. The selected AI model evaluates each code block execution and selects a code block based on completing the task in a way that most adheres to the quality parameter. The selected code block is returned via a user interface. The selected code block may be stored in a configuration code building block library associated with the quality parameter and the task and used when developing and revising software for the industrial automation environment.

### TECHNICAL FIELD

Various embodiments of the present technology generally relate to industrial automation software development. More specifically, embodiments relate to the development and curation of control software for industrial automation devices in industrial automation environments.

### BACKGROUND

Automated labor is an increasingly common means for executing tasks in commercial settings. Industrial automation environments use machinery, control systems, and other technologies to execute tasks that would otherwise be performed by humans. Automation technologies include robotics, numerical control systems, programmable logic controllers, various sensor technologies, and more. Industrial automation devices are automation technologies that execute tasks in industrial automation environments (IAE) or in other industrial applications.

Generally, IAE's can be managed by control software. Control software is software that uses control logic to dictate the operations of a device or program. As new industrial automation technology develops and automated labor systems become increasingly complex, the complexity and need for flexibility of control software processes in IAEs also evolves rapidly.

Instantiating and updating control software for the devices of an IAE represents a considerable challenge. In addition to challenges that result from actual development, engineers commonly track disparate versions of task executing control software, evaluate which versions of task executing control software satisfy various criteria, and maintain libraries of code building blocks as places to begin development of new pieces of control software. Further, engineers often track code block versions, evaluate code block characteristics, and maintain code block libraries for both software they have personally developed and for software that others have developed. Such tracking and evaluation by engineers is not efficient or consistent. Accordingly, often the most effective code blocks are not used, code blocks to perform the same tasks are rewritten, and so forth.

Accordingly, improvements are needed for code block development and code building block library supervision such that design and use of code blocks can be flexibly, efficiently, and scalably applied in modern IAE's.

### SUMMARY

Systems and methods are provided herein for development and storage of control software for devices in industrial automation environments (IAE). The methods and systems disclosed herein reduce the extent of development, testing, and integration typically accumulated in deploying new control software or updated control software to a device of an IAE. Avoiding the deployment of flawed or inferior code blocks to an IAE or avoiding the use of flawed or inferior code blocks as development starting points, significantly decreases wasted time and resources lost to software flaws or inferiorities, both in the function of devices that would otherwise have flawed or inferior control software, and in the time needed to remedy code blocks with flaws or inferiorities.

The generative artificial intelligence (AI) code block selector and codebase updating system disclosed herein includes a code block repository that stores a number of code blocks. Each code block is designed to execute on a controller in an IAE using industrial automation devices. A codebase refers to a collection of code blocks. The generative AI code block selector and codebase updating system also includes an AI model library that stores a number of AI models. The AI models are trained to analyze executions of the code blocks performed in an isolated testing environment. The generative AI code block selector and codebase updating system further includes a code block selector.

The code block selector receives configuration criteria from the user interface of a client device. The configuration criteria may include a task and a quality parameter. The code block selector receives a group of code blocks from the code block repository, where each code block is configured to perform a task when executed. An AI model is selected from a group of AI models based on the configuration criteria. Each code block of the group of code blocks received by the code block selector is executed in an isolated testing environment and the execution is evaluated by the selected AI model. Based on the quality parameter included in the configuration criteria and evaluations of each of the code blocks, the AI model identifies a selected code block and provides the selected code block via the user interface.

In an embodiment of the technology disclosed herein, a configuration code building block library is included. The configuration code building block library stores a selected code block for a given task and a given quality parameter. A given task may be associated with multiple selected code blocks. In yet another embodiment, the configuration code building block library is connected to the code block selector by a communication line having a security gateway as a node between the two end points. The security gateway is configured to limit access to an enterprise's configuration code building block library by unauthorized parties.

In an embodiment, a code block repository is further included. A code block repository holds all the disparate code block versions that perform various tasks relevant to an IAE when executed. In such an embodiment, the code block repository provides the group of code blocks to the code block selector for evaluation. In a further embodiment including a code block repository, the code block selector and the code block repository are connected by a communication line having a code block sanitizer as a node between the end points. The code block sanitizer is configured to take a code block as an input and to generate a sanitized code block as an output. Sanitized code blocks are delivered to the code block selector for evaluation.

In yet another embodiment, the code block selector includes a processor, a memory, a user interface, a communication module, and isolated code block testing environment, and an AI model selector engine. In such an embodiment, the memory stores instructions, that when executed by the processor, cause the processor to carry out the functions of a generative AI code block selector and codebase updating system.

In another embodiment, the AI model library includes a tiered list of AI models. Each tier of the AI model library is associated with a specific degree of domain specific training that each of the AI models of that tier possesses. In an example of such an embodiment, a first tier in the AI model library may represent one or more AI models having the lowest volume of domain specific training, and thus generally, the broadest skill set relative to other models in the AI model library. The example may also include a second tier. The second tier in the AI model library represents one or more AI models having an increased volume of domain specific training over the AI models of the first tier. As a result, AI models of the second tier may be capable of domain specific tasks that the first tier of AI models are not capable of. AI models trained on a high degree of domain specific data will have an increasing ability to effectively carry out specialized tasks, but also experience a deterioration in their ability to carry out more generalized tasks. Advantageously, an AI model library having tiers associated with varying degrees of domain specific training data allows a developer to select an AI model for code block evaluation that has a particular ability to perform domain specific tasks, a particular ability to perform generalized tasks, or a balance of both skill sets depending on the code block to be evaluated.

In another embodiment of the technology described above, the user interface of the client device may be an IAE programming design application. An IAE programming design application allows a developer to explore various systems and associated devices to review and develop control software for the devices. In an example, such an IAE programming design application includes a system explorer for viewing different systems and the devices of those systems, a development environment for the creation and editing of code blocks, and a programming design application toolbox. In a further example, the IAE programming design application displays a current code block for a selected device such that a developer can compare a code block currently under development with the code block currently controlling the device. The programming design application toolbox has an interactable element, that when triggered, launches a dedicated interface for the generative AI code block selector and codebase updating system.

Some embodiments of the present technology include a dedicated generative AI code block selector and codebase updating system interface. In an example of such an embodiment, various code blocks can be chosen for evaluation via the interface. The code blocks available for selection may be curated such that only code blocks associated with a given task are gathered or may alternatively represent a broad variety of tasks. Further, an AI model can be selected from the AI model library via the user interface. In some embodiments, the

This Summary is provided to introduce a selection of concepts in a simplified form that are further described below in the Detailed Description and is not intended to be limiting of other embodiments of the present technology apparent to those skilled in the art. As will be realized, the technology is capable of modifications in various aspects, all without departing from the scope of the present invention, and as such, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system diagram of a generative artificial intelligence (AI)code block selector and codebase updating system in accordance with some embodiments of the present technology.

FIG. 2 illustrates a system diagram of a generative AI code block selector and codebase updating system in further detail in accordance with some embodiments of the present technology.

FIG. 3 illustrates a diagram of a tiered AI model library in accordance with some embodiments of the present technology.

FIG. 4 illustrates a block diagram of a method of code block selection and codebase updating in accordance with some embodiments of the present technology.

FIG. 5 illustrates an industrial automation environment programming design application interface in accordance with some embodiments of the present technology.

FIG. 6 illustrates a generative AI code block selector and codebase updating system interface in accordance with some embodiments of the present technology.

FIG. 7 illustrates a further instance of a generative AI code block selector and codebase updating system interface in accordance with some embodiments of the present technology.

FIG. 8 illustrates an example computing system used in some embodiments of the present technology.

### DETAILED DESCRIPTION

As described above, various embodiments of the present technology generally relate to a generative artificial intelligence (AI) code block selector and codebase updating system.

Instantiating and updating control software (also called control code and control logic throughout) for the devices of an industrial automation environment (IAE) represents a considerable challenge. In addition to challenges that result from actual development, engineers commonly track disparate versions of task executing control software, evaluate which versions of task executing control software satisfy various criteria, and maintain libraries of code building blocks as places to begin development of new pieces of control software. Further, engineers often track code block versions, evaluate code block characteristics, and maintain code block libraries, or codebases, for both software they have personally developed and for software that others have developed. Engineer tracking and evaluation of large inventories of code blocks is not efficient or consistent. As such, code blocks to perform the same tasks are rewritten, the most efficient code blocks are often not used, and code blocks to achieve specifically desired results are often not available or identified.

To overcome these obstacles, systems and methods are provided herein for development and storage of control software for devices in industrial automation environments (IAE). The methods and systems disclosed herein reduce the extent of development, testing, and integration typically accumulated in deploying new control software or updated control software to a device of an IAE. The system accepts configuration criteria that dictate what an execution of a code block is expected to do and in what manner the execution should ideally occur. The manner the execution should occur in is described by a quality parameter of the configuration criteria. With a task and quality parameter from the configuration criteria, the system further accepts a subset of code blocks to evaluate. The system executes each of the code blocks in a testing environment and uses an AI model to analysis the executions. With respect to the task and quality parameter of the configuration criteria, the AI model identifies a selected code block. The selected code block is a code block that, as determined by the AI model, achieves the task of the configuration criteria with the highest degree of adherence to the quality parameter. The selected code block can be sent to a configuration code building block library for storage, review, and future use in subsequent control software development. Avoiding the deployment of flawed or inferior code blocks to an IAE or avoiding the use of flawed or inferior code blocks as development starting points, significantly decreases wasted time and resources lost to software flaws or inferiorities, both in the function of devices that would otherwise have flawed or inferior control software, and in the time needed to remedy code blocks with flaws or inferiorities. A given code block may be flawed for a number of reasons, including failure to perform a given task or to configure a given device, inefficient task performance or device configuration, security vulnerabilities, or lack of scalability. In some examples, a “flaw” in a code block is not a failure to perform a task or configure a device, but rather to perform a task or configure a device in an intended or expected manner. In other examples, metrics used to evaluate the success or failure of a code block may be unique to a particular IAE application. Streamlining control software development and deployment directly increases the efficiency and flexibility of an IAE. With less wasted time and resources, new or modified control software can be installed in an IAE more quickly and more often than previous systems and methods for control software development.

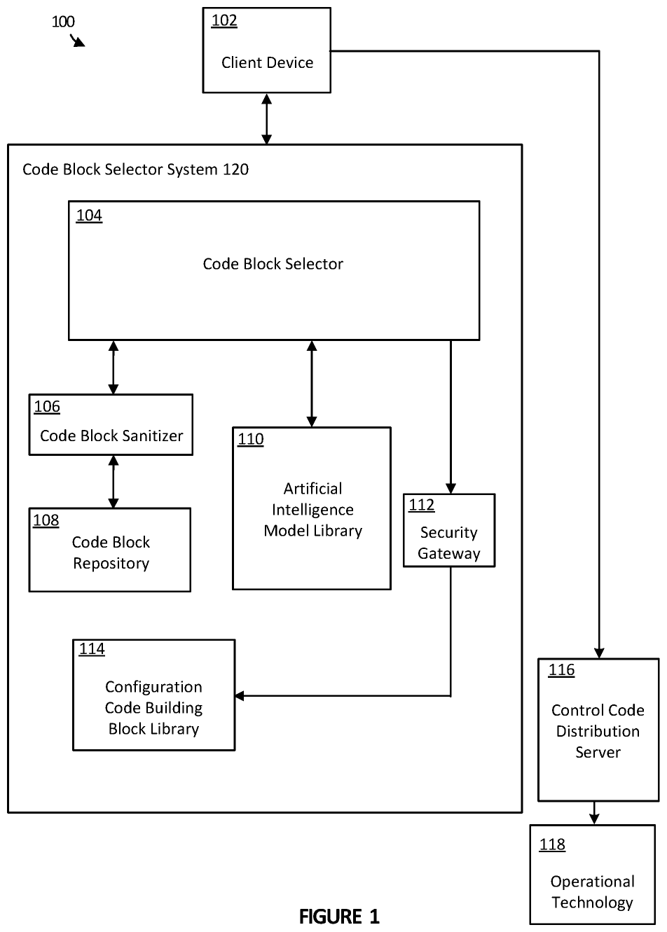

Turning now to the figures, FIG. 1 illustrates a system diagram of a generative AI code block selector and codebase updating system (system 100). System 100 includes client device 102, code block selector system 120, control code distribution server 116, and operational technology 118. Code block selector system 120 includes code block selector 104, code block sanitizer 106, code block repository 108, AI model library 110, security gateway 112, and configuration code building block library 114. Some embodiments may not include code block sanitizer 106, security gateway 112, configuration code building block library 114, control code distribution server 116, operational technology 118, or a combination thereof. Other elements may be present in system 100 but have been omitted for clarity.

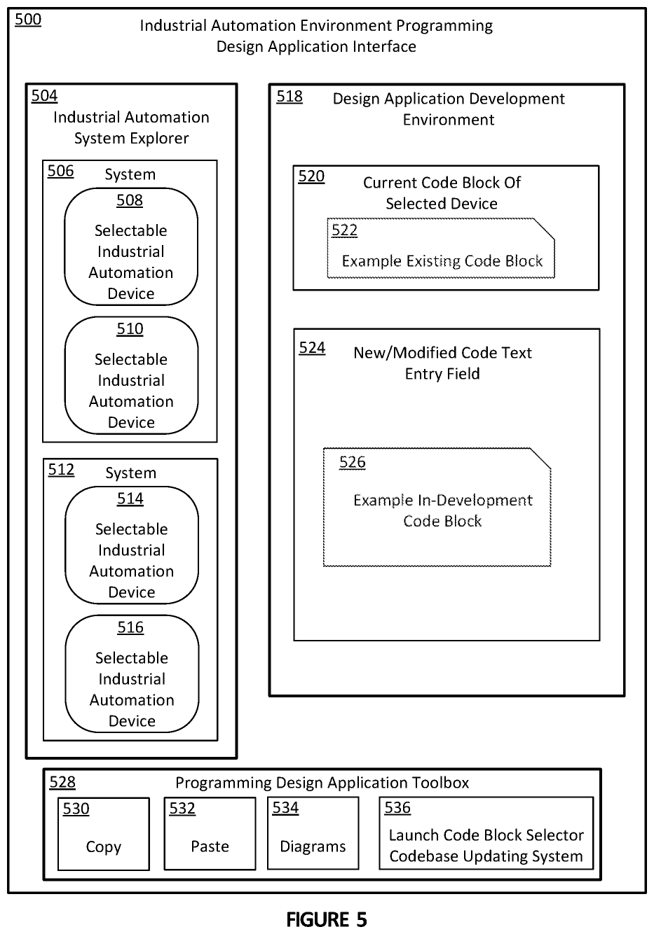

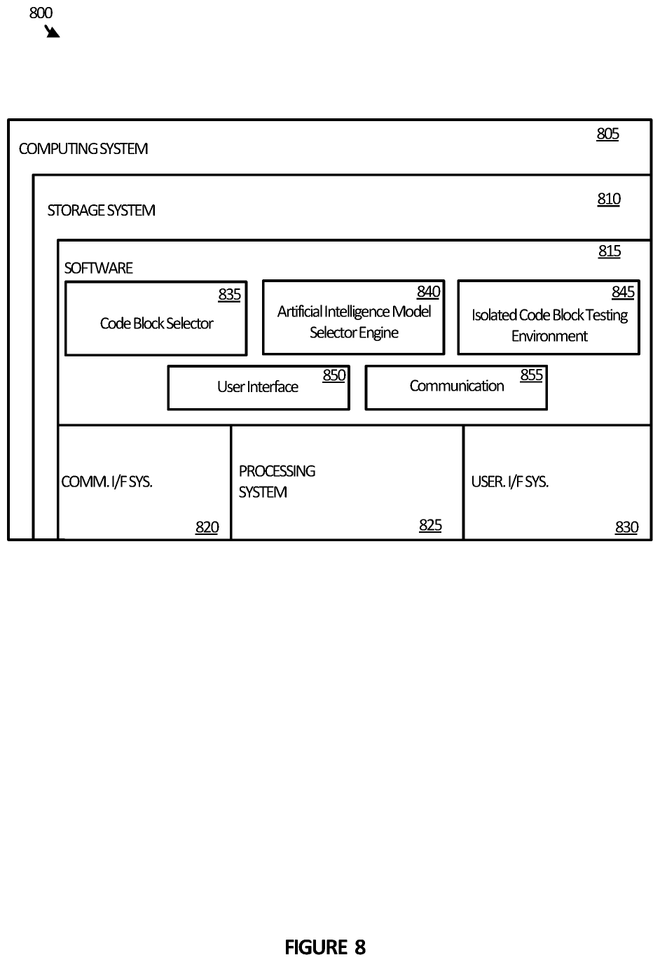

Client device 102 represents any computing device capable of rendering a user interface, such as general computing system 800 of FIG. 8. In some examples, client device 102 hosts a software development environment. Client device 102 may also be a local physical computing device that accesses a software development environment hosted on, for example, a distributed cloud computing device. Client device 102 is communicatively connected to code block selector 104 by a communication line. The communication line may be part of a local area network connection or may be a wireless network connection. Client device 102 may be located on the premises of an IAE or in a remote location. Client device 102 is configured to display a user interface and accept a command executable against a device of an IAE. In an example where client device 102 includes a software development environment, such as IAE programming design application interface 500 of FIG. 5, client device 102 could be a remote computer in an administrative location away from an IAE. In such an example, client device 102 renders a user interface in which a user develops code blocks for deployment to a device in an IAE. Code blocks under development may include software to drive a motor, advance a conveyor, monitor a system, deploy a configuration, or update a configuration. From such a user interface, the user may trigger, or may be prompted to trigger, code block selector 104.

Code block selector system 120 may be implemented on premises or remotely, and may be implemented as a hosted service, in some embodiments. Code block selector system 120 includes the components to implement the functionality for code block selection and updating as described in detail herein. Code block selector system 120 includes code block selector 104, code block sanitizer 106, code block repository 108, artificial intelligence model library 110, security gateway 112, and configuration code building block library 114. More or fewer components may be used in code block selector system 120 to implement the described functionality without departing from the scope and spirit of this disclosure.

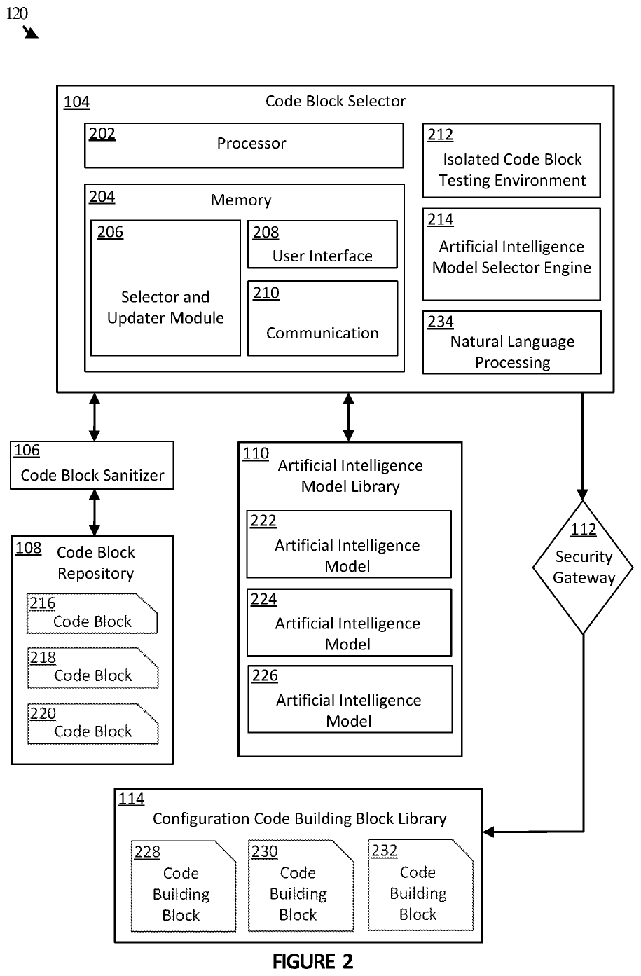

Code block selector 104 provides functionality for identifying and selecting code blocks based on criteria and, in some cases, updating code block libraries as described herein. Further detail on code block selector 104 is described in the associated text of FIG. 2. Code block selector 104 may be hosted by any computing device capable of performing the functionality described associated with code block selector 104, such as general computing system 800 of FIG. 8. Similarly, to client device 102, code block selector 104 may be located on the premises of an IAE or in a remote location. Where code block selector 104 is hosted on the premises of an IAE, a controller hosting code block selector 104 may be independent or may be integrated into an industrial automation device such as a conveyor or a sorting machine. Code block selector 104 may also be hosted as a service, which could be hosted on the premises of the IAE or in a remote location (e.g., a cloud-based service). Code block selector 104 includes software, described in more detail in FIG. 2, that obtains a subset of code blocks for completing a given task and analyzes the code blocks in an isolated testing environment to determine which of the subset of code blocks performs the task in a way that adheres most closely with a given performance criteria. For example, which of the subset of code blocks is most energy efficient may be identified when the quality parameter of the configuration criteria is energy efficiency. In such an example, code block selector 104 analyzes the execution of the subset of code blocks to determine which of the subset of code block executes the task while consuming the least resources compared with the other code blocks of the subset of code blocks. Where one code block executes the task and consumes 1 watt-hour of electricity and another code block executes the task while consuming 5 watt-hours of electricity, the first of the two code blocks consumes less efficient and would be returned by code block selector 104 as the most energy efficient execution of the evaluated code blocks. In another example, which of the subset of code blocks completes the task most quickly may be identified when the quality parameter of the configuration criteria is task execution time. In such an example, code block selector 104 analyzes the execution of the subset of code blocks to determine which of the subset of code block completes the task in the shortest amount of time compared with the other code blocks of the subset of code blocks. Where one code block completes the task in 100 milliseconds and another code block completes the task in 200 milliseconds, the first of the two code blocks has a faster execution of the task and will be returned by code block selector 104 as the code block having the fastest execution of the evaluated code blocks. In one other example, which of the subset of code blocks is most secure may be identified when the quality parameter of the configuration criteria is security vulnerability. In such an example, code block selector 104 analyzes the execution of the subset of code blocks to determine which of the subset of code block executes the task while exposing the greater system to the least amount of security vulnerability compared with the other code blocks of the subset of code blocks. Where one code block executes the task and opens no external communication channels while another code block executes the task while opening several communication channels, the first of the two code blocks has theoretically incurred fewer potential security risks (an existing communication channel potentially be used maliciously while that risk is eliminated where no communication channel is open) and would be returned by code block selector 104 as the most secure execution of the evaluated code blocks.

Code block selector 104 is communicatively connected to code block sanitizer 106, AI model library 110, and security gateway 112. Code block sanitizer 106 is further communicatively connected to code block repository 108, and security gateway 112 is further communicatively connected to configuration code building block library 114. Code block sanitizer 106 and security gateway 112 respectively function as communication nodes that supervise transmissions between the end points the nodes connect. Code block sanitizer 106 and security gateway 112 may be omitted in some embodiments of the current technology. Sanitizing a code block includes the elimination of unwanted or unsafe characters in a code block to ensure format validity.

Code block sanitizer 106 may anonymize a code block by removing explicit references to internal enterprise data or policies where possible. Upon generating a sanitized code block, code block sanitizer 106 transmits the sanitized code block to code block selector 104. For example, a code block may contain functionality that drives a series of motors in an IAE and also contains sensitive or confidential information including details about processes at use in an IAE. When such a code block is transmitted between code block selector 104 and code block repository 108, code block sanitizer will obscure or remove the sensitive or confidential information to the extent possible as an additional layer of communication security. In some examples, anonymized code blocks may later have sensitive and confidential information added back upon reception at code block selector 104, code block repository 108, or via other secure communication methods.

Code block sanitizer 106 may be application code local to a controller hosting code block selector 104 or may be instructions stored in a cloud server. Code block repository 108 may be any local or remote memory sufficient to store a number of code blocks. Code block repository 108 could be local to the computing environment of client device 102 or code block selector 104, respectively, or could be held in cloud storage.

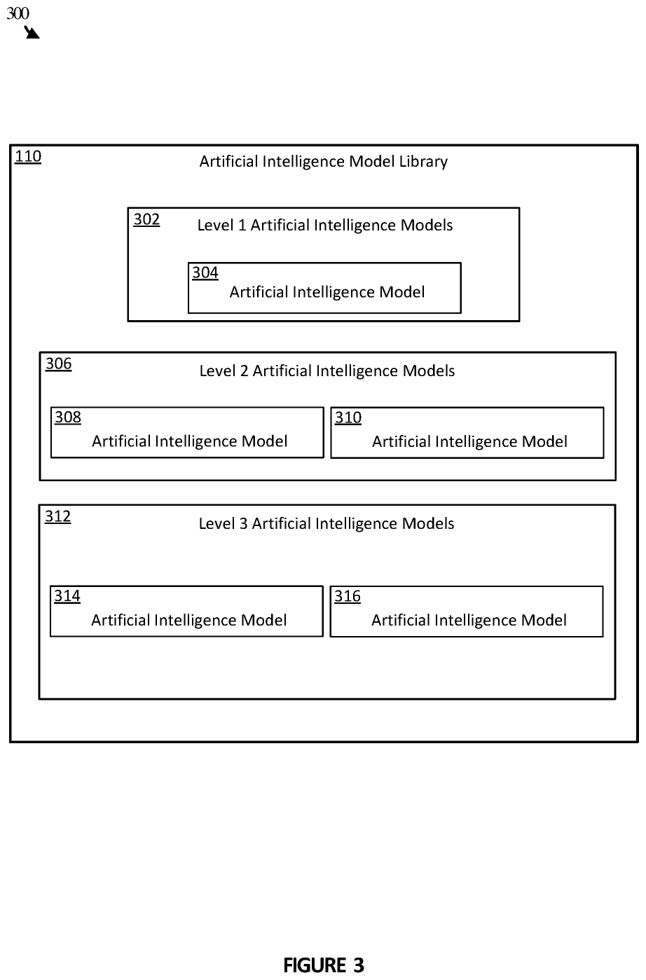

AI model library 110 is configured to store AI models that can be called upon for use by code block selector 104. AI model library 110 may be any local or remote memory sufficient to store a number of AI models. AI model library 110 could be local to the computing environment of client device 102 or code block selector 104, respectively, or could be held in cloud storage. In an example, where a user triggers code block selector 104, an AI model of the one or more AI models stored in AI model library 110 are requested by code block selector 104. The requested model is then transmitted to code block selector 104 for use. In some examples, AI model library 110 is a tiered library of AI models. Such examples are described in depth in detailed diagram of AI model library 300 and associated text of FIG. 3.

Configuration code building block library 114 is configured to store selected code blocks that can be used in system 100. Configuration code building block library 114 could be any local or distributed storage sufficient to store one or more code blocks. The selected code blocks stored by configuration code building block library 114 are chosen by code block selector 104 for their satisfaction of a given configuration criteria. Where code block selector 104 determines that a given code block most satisfies a configuration criteria compared to other code blocks evaluated, a user may choose to add the given code block to configuration code building block library 114. In other examples where code block selector 104 determines that a given code block most satisfies a configuration criteria, a user may choose not to add the given code block to configuration code building block library 114. In such an example, a user may alternatively choose to import the given code block into a current project. In other examples, a user may choose to import a given code block into a current project in addition to adding the given code block to configuration code building block library 114. In yet other examples, a user may choose to store other code blocks in configuration code building block library 114 in addition to selected code blocks.

Control code distribution server 116 may be any server implemented on premises or in a cloud-based environment that distributes control code to industrial automation controllers or other industrial automation devices (collectively, operational technology 118). In some factory environments, control code distribution server 116 distributes and updates control code, instruction sets, and the like to all operational technology 118 in the factory environment. Client device 102 may generate new control code using code block selector 104 in an industrial design environment (e.g., a software development environment such as RSLOGIX 5000®) for one or more operational technology 118 and transmit the control code to control code distribution server 116 for distribution to the relevant operational technology 118.

Operational technology 118 may be any industrial automation device that operates based on control code. Operational technology 118 may include programmable logic controllers (PLC) or any other industrial automation device that executes control code in a factory environment (i.e., IAE).

In use, code block selector 104 receives configuration criteria from the user interface of client device 102. Configuration criteria may also be submitted to code block selector 104 in a natural language format. Should the configuration criteria be given in natural language, a natural language processing component (e.g., natural language processing 234) translates the input into pieces a processor can operate on, here being a task and a quality parameter. A task is any objective relevant to an IAE that would be carried out by an industrial automation device. Examples of a task include the jogging of a motor, the halting of a conveyor, control logic configuration, setting or parameter configuration, or the entry of an industrial device into a safe state. A quality parameter is any metric relevant to the execution of tasks in an IAE. Examples of a quality parameter include fastest execution of a task, most energy efficient execution of a task, or most secure execution of a task. For example, where code block selector 104 receives a configuration criteria from client device 102 that states “the most energy efficient execution of motor jogging code,” the task is the jogging of a motor, and the quality parameter is most energy efficient execution. A given task may be associated with multiple selected code blocks where each selected code block is correlated with a different quality parameter. In an example where a task of a configuration criteria is to jog a motor a given increment, different code blocks may be identified by code block selector 104 and stored in configuration code building block library 114 for different quality parameters. One code block may be selected by code block selector as a most energy efficient execution of a motor jogging code, while another code block may be selected by code block selector 104 as one having a fastest execution of a motor jogging code.

Code block selector 104 receives a group of code blocks from code block repository 108, where each code block is configured to perform the task of the configuration criteria when executed. Comparing executions of each code block of the group of code blocks provides the basis by which a code block can be selected for its relative performance of a task with regard to the quality parameter. Evaluation of code block execution and comparison of code block executions is carried out by an AI model. An AI model is selected from a group of AI models stored in AI model library 110 based on the configuration criteria. Further detail on selection of an AI model is included in the associated text to FIG. 3. In an embodiment, the group of code blocks are selected from code block repository 108. Each code block of the group of code blocks received by code block selector 104 is executed in an isolated testing environment and the execution is evaluated by the selected AI model. The AI model carries out the evaluation of the code blocks by analyzing each execution of each code block and measuring relevant values for the execution. For example, where a quality parameter of fastest execution is received, the AI model evaluates the execution of each code block to determine whether the task has been completed, and where completed, how long the completion took. By comparing the completion time for each code block having successfully completed the task, the AI model can identify a selected code block by selecting the fastest time. The AI model will evaluate other metrics of an execution of code block, such as clock cycles used, or energy consumption, to determine selected code blocks for other quality parameters. Once the AI model identifies a selected code block, the selected code block is provided to client device 102 via the user interface. The user may opt to include the selected code block into a current project, add the selected code block to configuration code building block library 114, or a combination thereof.

When the current project is complete, the completed control code may be transmitted to control code distribution server 116 for distribution and execution on operational technology 118.

FIG. 2 illustrates a system diagram of Code block selector system 120. Code block selector system 120 as depicted in FIG. 2 includes further detail than in FIG. 1. As in FIG. 1, code block selector system 120 includes code block selector 104, code block sanitizer 106, code block repository 108, AI model library 110, security gateway 112, and configuration code building block library 114. Code block selector 104, code block sanitizer 106, code block repository 108, AI model library 110, security gateway 112, and configuration code building block library 114 are described above and include additional detail below.

Code block selector 104 as depicted in FIG. 2 includes processor 202, memory 204, isolated testing environment 212, AI model selector engine 214, and natural language processing 234. Memory 204 further includes selector and updater module 206, user interface 208, and communication 210. In some embodiments, code block selector 104 is not implemented in a separate computing device but is instead hosted on a server in a cloud-based environment or on premises. In various embodiments, code block selector 104 may not include processor 202 or memory 204 explicitly used for code block selector 104. Rather, in a distributed or hosted environment, the functionality described in selector and updater module 206, isolated code block testing environment 212, artificial intelligence model selector engine 214, and natural language processing 234 may be implemented in any suitable hardware, software, firmware, or combination configuration.

As described in detail above, code block selector 104 may be any computing device capable of rendering a user interface, sending messages, and receiving messages, such as a logic controller. General computing system 800 of FIG. 8 is generally representative of devices capable of hosting code block selector 104. Memory 204 stores instructions, such as selector and updater module 206, user interface 208, and communication 210, that when executed by processor 202, cause processor 202 to carry out the functions of code block selector 104. Memory 204 is stored in the same location code block selector 104, but in other examples may be stored remotely or in different local storage than code block selector 104. When a user triggers code block selector 104, processor 202 fetches instructions from selector and updater module 206, user interface 208, and communication 210, respectively. Processor 202 then executes those respective instructions.

User interface 208 represents functionality for providing an interface to client device 102. An example of a user interface includes generative AI code block selector and codebase updating system interface 502 of FIG. 5. Communication 210 facilitates transmission and reception of messages between the code block selector 104, client device 102, code block repository 108, AI model library 110, and configuration code building block library 114. For example, where a user triggers code block selector 104, communication 210 facilitates transmission of code blocks and configuration criteria that code block selector 104 will operate on.

Isolated testing environment 212 is a dedicated location for code block executions that is isolated from the rest of code block selector 104 functionality such that code block executions do not affect other ongoing processes. In one example, isolated testing environment 212 is a sandbox testing environment. In some embodiments, isolated testing environment 212 simulates features of the intended application environment. Here, execution of a code block in isolated testing environment 212 produces results substantially the same as would be expected when executing a code block in its intended application environment. For example, where the execution of a code block results in a conveyor being directed to incrementally advance a motor, isolated testing environment 212 simulates the conveyor device such that when the code block is executed in isolated testing environment 212, the performance of the code block can be evaluated as if the code block was being executed in the actual IAE the device in question sits in.

AI model selector engine 214 is configured to accept configuration criteria as an input and to select a model for use in evaluating executions of the subset of code blocks in isolated testing environment 212. In some examples, a user will select regularly use a generally trained AI model. In other examples, a user may purposefully select an AI model for its high or low degree of training data specificity. In further examples, a user may opt for AI model selector engine 214 to select the AI model. In such examples, AI model selector engine is fed the configuration criteria, which is used to evaluate the specificity of the task. For instance, a task that could be adequately evaluated by an AI model only having general training may be a device status query. Generalized training is sufficient to understand which device is targeted, to understand the nature of the status query, and to retrieve the status from a device. In another case, a task that that can only be evaluated by an AI model having high specificity training data could be configuring control logic for a newly installed articulated robotic device to perform highly specific object and motion actions. Here, configurating control logic for a complex machine performing a task that is generally difficult to assess the efficacy of. As such, the AI model selected to evaluate the task is a model trained on data with a high degree of specificity, particularly data relating to robotic motion and object tasks in industrial circumstances.

Natural language processing 234 takes as an input a configuration criteria that was submitted by a user in a natural language format. Where the user enters configuration criteria via client device 102 in natural language, the input is passed to natural language processing 234, which is configured to accept natural language inputs and output the relevant elements of configuration criteria for use by code block selector system 120. For example, a user on client device 102 may submit “Which one of my code blocks is faster than my current robot configuring code” as an input. Natural language processing 234 takes in the input and parses it for the relevant values of interest. Here, natural language processing 234 understands that the target device is a given robot, the task to be executed is a device configuration, and the quality parameter is speed of execution. Natural language processing 234 then sends this translation to the selected AI model to guide its evaluation of code block executions. In cases where the user prompts code block selector system 120 to select a subset of code blocks and an AI model on the user's behalf, natural language processing 234 sends the translated configuration criteria to AI model selector engine 214 and code block repository 108, respectively.

Code block repository 108 includes code block 216, code block 218, and code block 220. Code block 216, code block 218, and code block 220 are representative of a group of code blocks that each perform the same task. Other code blocks that perform other tasks may be included in code block repository 108 but have been omitted for clarity. Code block selector 104 is configured to receive the group of code blocks from code block repository 108 such that each code block can be executed and evaluated. For example, code block 216 may have been written by one developer, while code block 218 was written by another developer, and code block 220 may have been written by yet another developer. In such an example, a complete understanding of the functionality and performance metrics of each respective code block would typically require a developer to perform an in-depth evaluation of each code block and in some cases, an evaluation of the lines of code each code block is made up of. Advantageously, in the current example, the performance of a code block under ongoing development and its adherence to a given configuration criteria could be compared to respective performances of code block 216, code block 218, and code block 220 without requiring direct supervision. In some embodiments, categories of code blocks 216, 218, 220 include device configuration code for a device in an IAE, task execution code to be carried out by a device in an IAE, or other control software relevant to devices in an IAE. For example, device configuration code blocks may include software for initializing certain settings or parameters of a device in an IAE or deploying security protocols to a device in an IAE. In examples where the task executed by the code blocks relate to a device performing an action, such code blocks may include jogging a motor of a device, beginning or halting a pre-defined process of a device, or entering a particular state of a device. In examples of code blocks where the task is a configuration of a device, such code blocks may include an initial configuration of a device, a reconfiguration of a device, or the application of control logic that governs subsequent action of a device in an IAE. Control logic is generally used to define a device's behavior for automated function. For example, the task of a code block may be to configure an automated thermostat in an IAE. Control logic for the thermostat could include an upper limit of 80 degrees Fahrenheit, a lower temperature limit of 60 degrees Fahrenheit, and corrective actions to lower and raise the temperature for breaches of the upper and lower temperature limits, respectively. In operation, an ambient temperature of 58 degrees would be recognized by the thermostat as beyond one of its limits, in response to which, the thermostat would increase the temperature to bring the ambient temperature back within the defined range. Some examples of control code may trigger certain actions in ongoing processes, while other examples of control code trigger the beginning or end of various processes.

AI model library 110 includes AI model 222, AI model 224, and AI model 226. Additional AI models may be housed in AI model library 110 but have been omitted for clarity. A single AI model is selected from AI model 222, AI model 224, and AI model 226, and provided to code block selector 104. Code block selector 104 leverages the selected AI model to evaluate the execution of a code block. In some embodiments of the technology, AI model library 110 comprises a tiered organizational structure for the AI models stored therein. AI models trained on varying degrees of training data specificity are equipped to satisfy varying degrees of task specificity as a direct result. In example of an embodiment, AI model 222 is trained on highly general training data, while AI model 226 is trained on highly specific training data. In this example, general training data refers to training data that allows an AI model to understand high level concepts such as physical interactions of objects, human communication, or general safety concepts for industrial environments. In contrast, specific training data refers to training data that allows an AI model to understand more nuanced and narrowly applied concepts, such as troubleshooting for a specific complicated device or industrial issues. In such examples, generative AI models may be trained and configured to suggest efficient code block solutions for executing the task a user has submitted via the configuration criteria. In these examples, the AI models of AI model library 110 take in as an input the configuration criteria, and where applicable, the code block currently under development, and produces a new code block or a newly modified version of an existing user-developed code block that performs the task in a way that satisfies the quality parameter.

Security gateway 112 may be implemented as an application stored on a local computing device or may be hosted on a distributed network. Where code block selector 104 has identified a selected code block, the selected code block may be added to configuration code building block library 114 automatically or upon direction of a user. In some embodiments, security gateway 112 acts as an intermediary between code block selector 104 and configuration code building block library 114. In such embodiments, security gateway 112 is configured to provide additional communication security for the transmission of code blocks. Where code blocks contain confidential or sensitive data about a particular enterprise or industrial environment that was not obscured or removed by code block sanitizer 106, security gateway 112 provides additional protection. Security gateway 112 provides additional protection to code block transmission via any number of currently available network security protocols, such as Internet Protocol Security (IPSec) Protocol, Secure Sockets Layer Protocol, and Simple Network Management Protocol, as examples. These protocols are well known and will not be discussed further here.

Configuration code building block library 114 includes code building block 228, code building block 230, and code building block 232. Code building block 228, code building block 230, and code building block 232 are selected code blocks that have previously been determined to be a selected code block by code block selector 104 with regard to a given configuration criteria. For example, code building block 228 may be a selected code block for an energy efficient motor jogging program, code building block 230 may be a selected code block for a fastest motor jogging program, and code building block 232 may be a selected code block for a fastest conveyor shut-down program. Code blocks stored in configuration code building block library may all be associated with a single task or may be associated with any number of tasks. In some examples, a given code block may be associated with more than one task, and one or more quality parameters may apply to each of the tasks.

In use, a user developing a code block triggers, or is prompted to trigger, code block selector system 120. Via an interface (e.g., generative AI code block selector and codebase updating system interface 600), the user selects the subset of code blocks to be evaluated, selects the AI model to evaluate executions of each code block, and enters a configuration criterion. In some cases, the user directs code block selector 104 to select the subset of code blocks from code block repository 108 and the AI model from AI model library 110 on behalf of the user. Code block selector receives the subset of code blocks from code block repository 108 and an AI model from AI model library 110, where each code block is configured to perform a task when executed and the AI model is trained to evaluate each task execution and compare them. The code blocks available for selection and evaluation are represented by code block 216, code block 218, and code block 220. In examples where the subset of code blocks and the AI model are chosen by code block selector 104 on a user's behalf, code block selector 104 receives the configuration criteria and a prompt that causes AI model selector engine 214 to select an AI model from AI model library 110 and causes code block repository to supply code block selector 104 with all code blocks that execute the task of the configuration criteria.

In an embodiment, the group of AI models are selected from AI model library 110, where the available AI models are represented by AI model 222, AI model 224, and AI model 226. Each code block of code block 216, code block 218, and code block 220 received by code block selector 104 is executed in isolated testing environment 212 and the execution is evaluated by the selected AI model. The AI model carries out the evaluation of the code blocks by analyzing each execution of each code block and measuring relevant values for the execution. For example, where a quality parameter of fastest execution is received, the AI model evaluates the execution of each code block to determine whether the task has been completed, and where completed, how long the completion took. By comparing the completion time for each code block having successfully completed the task, the AI model can select a selected code block by selecting the fastest time. The AI model will evaluate other metrics of an execution of code block, such as clock cycles used, or energy consumption, to determine selected code blocks for other quality parameters. Once the AI model identifies a selected code block, the selected code block is provided to client device 102 via the user interface. In some embodiments, the user is prompted to determine if the selected code block should be added to configuration code building block library 114. For example, where a selected code block is identified, a user may opt to add, or not to add, the selected code block to configuration code building block library 114. Separately, a user may additionally opt to, or not to, import the selected code block into a current project. Examples of selected code blocks that have previously been added to configuration code building block library 114 include code building block 228, code building block 230, and code building block 232.

FIG. 3 illustrates a detailed diagram of AI model library 300. AI model library 110 of FIG. 3 is the same as AI model library 110 of FIG. 1 but includes further structural organization detail. AI model library 110 of FIG. 3 includes level 1 AI models 302, level 2 AI models 306, and level 3 AI models 312. Level 1 AI models 302 includes AI model 304. Level 2 AI models 306 includes AI model 308 and AI model 310. Level 3 AI models 312 includes AI model 314 and AI model 316.

Each of level 1 AI models 302, level 2 AI models 306, and level 3 AI models 312 are associated with a specific degree of domain specific training that each of the AI models on that tier possess. Level 1 AI models 302 is a first tier in the AI model library and represents storage for one or more AI models that have the lowest volume of domain specific training. AI model 304 is one such model. Because these models, such as AI model 304, have the least domain specific skill, they generally have the broadest skill set relative to other models in the AI model library. Level 2 AI models 306 represents storage for one or more AI models having an increased volume of domain specific training over level 1 AI models 302. AI model 308 and AI model 310 are examples of such models. As a result, Level 2 AI models 306 may be capable of domain specific tasks that the first tier of AI models are not capable of. Level 3 AI models, such as AI model 314 and AI model 316, are trained on a high degree of domain specific data and have an increased ability to effectively carry out domain specific specialized tasks. Level 3 AI models, however, experience the greatest degree of deterioration in their ability to carry out more generalized tasks compared to AI models with less domain specific training data. Advantageously, an AI model library having tiers associated with varying degrees of domain specific training data allows a developer to select an AI model for code block evaluation that has a particular ability to perform domain specific tasks, a particular ability to perform generalized tasks, or a balance of both skill sets depending on the code block to be evaluated. In some embodiments, a user interacting with a client device, such as client device 102 of FIG. 1, selects an AI model from the tiered lists in AI model library 110. In other embodiments, the AI model is chosen for the user by an AI model selector engine, such as AI model selector engine 214 of FIG. 2.

In addition to training specificity, AI models of AI model library 110 may also be organized in a number of other ways. For example, AI models may be organized for their relation to specific kinds of procedures, their relation to specific devices, their applicability in specific environments, their applicability to under specific commercial circumstances, for their adherence to specific standards, or for other characteristics. AI model library 110 can be visually presented to a user, for example via client device 102 of FIG. 1, such that the AI models stored therein are displayed with respect to one or more of the foregoing organization strategies. In one example, AI model library 110 may have a group of models specifically associated with executing code in a hazardous environment, while another group of models is specifically associated with an administrative setting. Both groups of models are configured to evaluate executions of code blocks, but the first group may have different foundational principles for successful operation, while the second group may not have been trained using any environmental safety concerns. In such an example, both groups of models may be further hierarchically organized with respect to the degree of training specificity an AI model is trained on. For instance, the group of models specifically associated with executing code in a hazardous environment may have a tiered organization structure isolated from other organizational structures in the rest of AI model library 110, where each tier is associated with a specific degree of training data specificity.

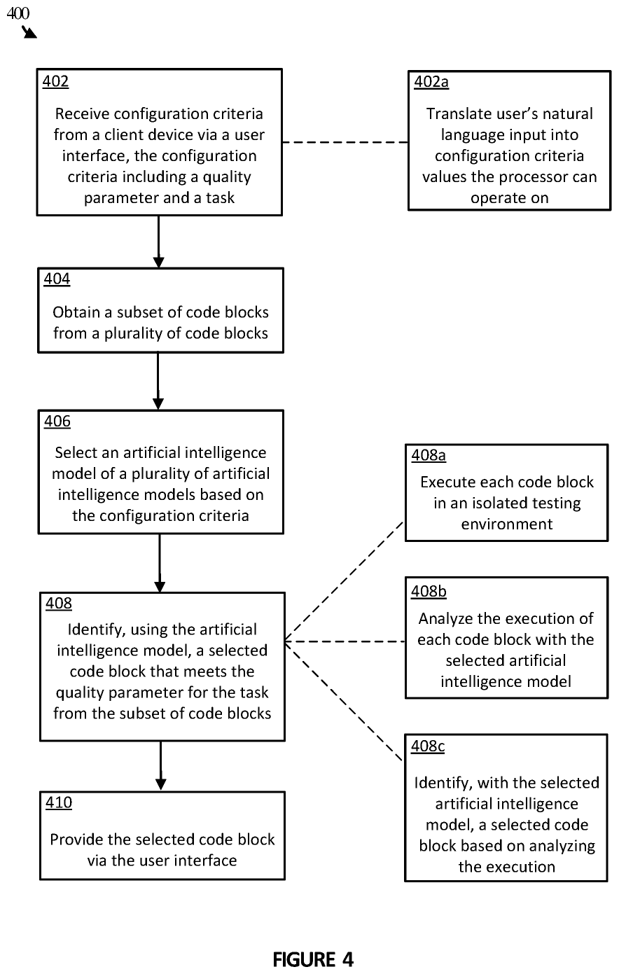

FIG. 4 illustrates a block diagram illustrating steps of a method for implementing a generative AI code block selector and codebase updating system. The steps of the method described herein do not necessarily need to be performed in the same order as the embodiment illustrated in FIG. 4.

Step 402 of the method 400 begins with the reception of a configuration criteria from a client device via a user interface. As described above, the configuration criteria include a task and a quality parameter. The configuration criteria are received by the code block selector. Step 404 of method 400 describes the code block selector's acquisition of a subset of code blocks. The subset of code blocks are stored in a code block repository, and individual code blocks can be selected for evaluation depending on a user's needs. In some embodiments, the code blocks are processed by a code block sanitizer during transmission from the code block repository to the code block selector. The code block sanitizer removes certain characters such that the transmitted code block is ensured to be in a format the code block selector can interpret. Step 406 of method 400 describes the selection of an AI model from a plurality of AI models based on the configuration criteria. In some embodiments, the AI model is chosen by a user, while other embodiments leverage an AI model selector engine to make a selection. Where the configuration criteria received by the code block selector entails either a task or a quality parameter that requires a high degree of domain specific skills to evaluate the execution of, an AI model trained on a higher degree of domain specific training data is chosen. Alternatively, where the configuration criteria received by the code block selector entails a task or quality parameter than can be evaluated by use of a broad general skillset, an AI model trained on broad general training data is used.

Step 408 of method 400 describes the identification of a selected code block. Step 408 of method 400 further includes step 408a, step 408b, and step 408c. At step 408a of method 400, the code block selector uses the selected AI model to evaluate the execution of each code block received by the code block selector. At step 408b of method 400, the AI model analyzes the execution of each code block received by the code block selector. At step 408c of method 400, the AI model evaluates each code block's execution to analyze the performance of the given task and adherence to the quality parameter. Once each of the code blocks has been executed and evaluated, the AI model compares the performance of each, and with respect to the configuration criteria, determines which code block is the selected code block. At step 410 of method 400 and in response to the determination of a selected code block, the code block selector provides the selected code block to the client device via the user interface. In some embodiments, the user interface also prompts the user to determine if the selected code block should be added to the configuration code building block library.

FIG. 5 illustrates an IAE programming design application interface 500 in accordance with some embodiments of the technology. IAE programming design application interface 500 includes industrial automation system explorer 504, design application development environment 518, and programming design application toolbox 528. Industrial automation system explorer 504 further includes system 1 506 and system 2 512. System 1 506 includes selectable industrial automation device 1 508 and selectable industrial automation device 2 510. System 2 512 includes selectable industrial automation device 3 514 and selectable industrial automation device 4 516. Design application development environment 518 includes current code block of selected device 520, which includes an example existing code block 522. Design application development environment 518 further includes new/modified code text entry field 524, which includes example in-development code block 526. Programming design application toolbox 528 further includes copy 530, paste 532, diagrams 534, and launch code block selector and codebase updating system 536.

IAE programming design application interface 500 allows a developer to explore various systems, such as system 1 506 and system 2 512, and associated devices, such as selectable industrial automation device 1 508, selectable industrial automation device 2 510, selectable industrial automation device 3 514, and selectable industrial automation device 4 516, to review and develop control software for the devices. IAE programming design application interface 500 could be any sufficient industrial control software development environment capable of allowing a developer to create or modify code blocks.

In use, a developer working in IAE programming design application interface 500 selects the system and device they intend to develop or modify control software for, such as selectable industrial automation device 1 508 of system 1 506. Once selected, control software currently managing the device is displayed in the current code block of selected device 520. In an example, where selectable industrial automation device 1 508 of system 1 506 is chosen for development, example existing code block 522 represents the current control software dictating the operation of the device. New/modified code text entry field 524 allows the developer to begin modifying code blocks or developing new code blocks. In the current example, where the developer has chosen selectable industrial automation device 1 508 of system 1 506, example in-development code block 526 represents a newly modified or created code block. Advantageously, a developer will be able to easily compare example existing code block 522 with example in-development code block 526 to compare and contrast features of the code blocks. While working on example in-development code block 526, a developer may make use of programming design application toolbox 528 to assist in development. Copy 530, paste 532, and diagrams 534 are well known functionality of existing integrated development environments and will not be discussed in further detail. Launch code block selector and codebase updating system 536 allows the developer to launch a dedicated interface for the code block selector and codebase updating system. In the current example, where selectable industrial automation device 1 508 of system 1 506 is under development, triggering launch code block selector and codebase updating system 536 allows the developer to evaluate a subset of code blocks to determine which portions of the development process can be streamlined. For example, if selectable industrial automation device 1 508 of system 1 is a conveyer, and the developer intends to develop and deploy a fastest version of a motor jogger code block, triggering launch code block selector and codebase updating system 536 provides the developer with the means to avoid rewriting an existing code block where existing code blocks are sufficient, and to avoid integration challenges by evaluating executions of code blocks before they are deployed into live industrial automation contexts.

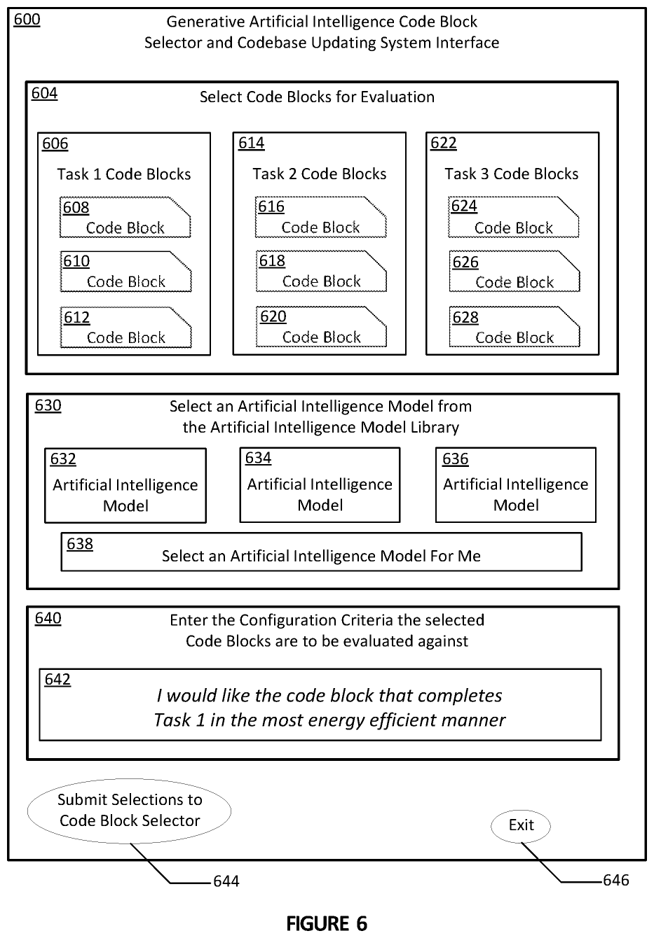

FIG. 6 illustrates a generative AI code block selector and codebase updating system interface 600 in accordance with an embodiment of the described technology. Generative AI code block selector and codebase updating system interface 600 could be a dedicated interface or could be a component of a larger interface. Generative AI code block selector and codebase updating system interface 600 includes select code blocks for evaluation 604, select an AI model from the AI model library 630, enter the configuration criteria the selected code blocks are to be evaluated against 640, submit selections to code block selector 644, and exit 646.

Select code blocks for evaluation 604 includes code blocks for task 1 606, code blocks for task 2 614, and code blocks for task 3 622. Each of code blocks for task 1 606, code blocks for task 2 614, and code blocks for task 3 622 contain a number of selectable code blocks that a user may direct the generative AI code block selector and codebase updating system to include in its evaluation.

Code blocks for task 1 606 includes code block 1.1 608, code block 1.2 610, and code block 1.3 612. Code block 1.1 608, code block 1.2 610, and code block 1.3 612 each perform the same specific task when each respective code block is executed by a processor, such as processor 202 of FIG. 2. Each respective code block may have one of or a combination of different features that align with a given quality parameter.

Code blocks for task 2 614 includes code block 2.1 616, code block 2.2 618, and code block 2.3 620. Code block 2.1 616, code block 2.2 618, and code block 2.3 620 each perform the same specific task when each respective code block is executed by a processor, such as processor 202 of FIG. 2. Each respective code block may have one of or a combination of different features that align with a given quality parameter.

Code blocks for task 3 622 includes code block 3.1 624, code block 3.2 626, and code block 3.3 628. Code block 3.1 624, code block 3.2 626, and code block 3.3 628 each perform the same specific task when each respective code block is executed by a processor, such as processor 202 of FIG. 2. Each respective code block may have one of or a combination of different features that align with a given quality parameter.

Select an AI model from the AI model library 630 includes AI model 1 632, AI model 2 634, AI model 636, and select an AI model for me 638. Each AI model available for selection in select an AI model from the AI model library 630 may be associated with a different degree of training data specificity. In some embodiments, the AI models are selected from a library of models organized into tiered lists, such as AI model library 300. Each tier of AI models has been trained on substantially the same degree of training data specificity such that they have a similar balance of domain specific skill versus generalized skill. Enter the configuration criteria the selected code blocks are to be evaluated against 640 includes an example configuration criteria input, I would like the code block that completes Task 1 in the most energy efficient manner 642.

In use, a user configures the generative AI code block selector and codebase updating system via generative AI code block selector and codebase updating system interface 600. Generative AI code block selector and codebase updating system interface 600 is configured to accept as an input a subset of code blocks to be evaluated, a selected AI model, and a configuration criteria.

Code blocks, such as code block 1.1 608, are chosen for their execution of a specific task in order to evaluate each selected code block's adherence to a quality parameter. In this embodiment, example configuration criteria I would like the code block that completes Task 1 in the most energy efficient manner 642 indicates that Task 1 is the objective to be completed, while the quality parameter is energy efficiency. As a result, any combination of code block 1.1 608, code block 1.2 610, and code block 1.3 612, each of which execute Task 1, can be selected for evaluation.

The AI model is selected based on the specificity of the task to be completed by a given group of code blocks as communicated by the configuration criteria. A higher degree of training data specificity generally improves an AI model's ability to execute tasks requiring a higher degree of domain specific skill while diminishing its ability to execute tasks requiring generalized skill. Conversely, a higher degree of broad generalized training data typically supports an AI model's ability to execute tasks requiring generalized skill while diminishing its ability to execute tasks requiring domain specific skill. Advantageously, and in response to the need to balance domain specific skill and generalized skill, a tiered library of AI models allows a developer to select a model with a specific degree of training specificity in order to evaluate the execution of a task that requires a congruent degree of skill specificity.

Upon input of a subset of code blocks, a selected AI model, and configuration criteria, a user can trigger submit selections to code block selector 644 to induce operation of the generative AI code block selector and codebase updating system. Where a user wishes to exit generative AI code block selector and codebase updating system interface 600 without having triggered operation of the generative AI code block selector and codebase updating system, exit 646 terminates generative AI code block selector and codebase updating system interface 600.

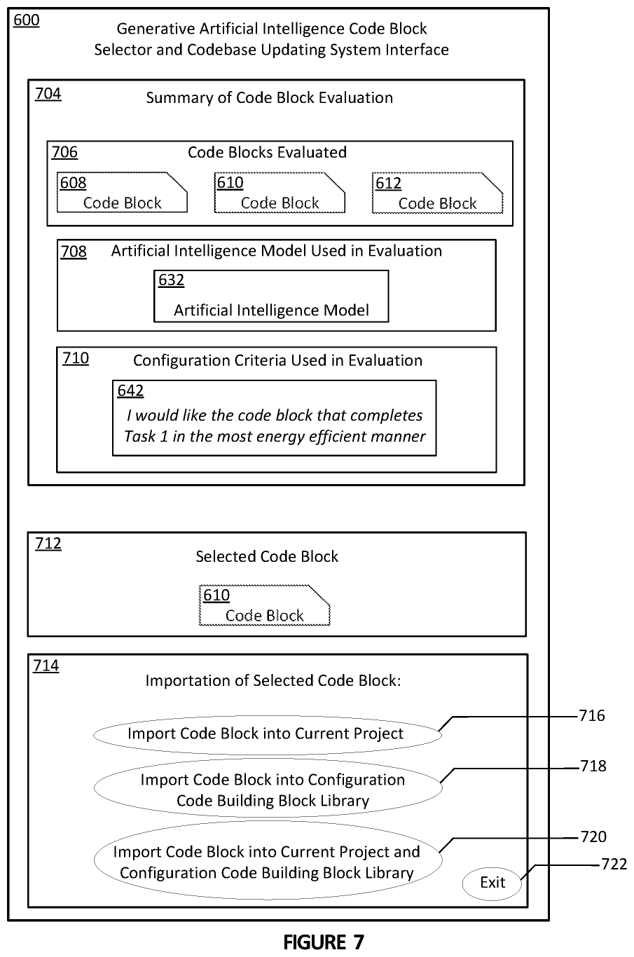

FIG. 7 illustrates a further view of generative AI code block selector and codebase updating system interface 600. Further view of generative AI code block selector and codebase updating system interface 600 illustrates summarized results of an operation of the generative AI code block selector and codebase updating system, and further includes summary of code block evaluation 704, selected code block 712, and importation of selected code block 714. Summary of code block evaluation 704 further includes code blocks evaluated 706, AI model used in evaluation 708, and configuration criteria used in evaluation 710. Code blocks evaluated 706 further includes code block 1.1 608, code block 1.2 610, and code block 1.3 612. The AI model used in evaluation 708 of the illustrated embodiment further includes AI model 1 632. Importation of selected code block 714 further includes import code block into current project 716, import code block into configuration code building block library 718, import code block into current project and configuration code building block library 720, and exit 722.

In use, where a launch of, configuration of, and operation of the generative AI code block selector and codebase updating system have been accomplished, generative AI code block selector and codebase updating system interface 600 displays a summary of the operation and the results. Summary of code block evaluation 704 describes the code blocks that have been evaluated in code blocks evaluated 706, AI model used in evaluation 708, and the configuration criteria used to inform the evaluation in configuration criteria used in evaluation 710.

In an example, code blocks evaluated 706 contains code block 1.1 608, code block 1.2 610, and code block 1.3 612, indicating that these code blocks were the subject of the completed operation. In the same example, the AI model used in evaluation 708 contains AI model 1 632, indicating that this AI model was used to evaluate the execution of the code blocks.

In an example, selected code block 712 contains code block 1.2 610. Having evaluated each of the executions of code block 1.1 608, code block 1.2 610, and code block 1.3 612, AI model 1 632 determined that code block 1.2 610 most aligned with example configuration criteria I would like the code block that completes Task 1 in the most energy efficient manner 642 by completing Task 1 in a more energy efficient manner than the other code blocks evaluated. Having received an indication of the selected code block via the user interface of a client device, a user may now choose the subsequent actions, if any.

Importation of selected code block 714 contains four different options for subsequent action after receiving a selected code block. Import code block into current project 716 allows a developer to import the content of selected code block, such as code block 1.2 610, into the integrated development environment, like IAE programming design application interface 500 of FIG. 5. Import code block into configuration code building block library 718 allows a developer to import the content of selected code block, such as code block 1.2 610, into a configuration code building block library, such as configuration code building block library 114 of FIG. 1. Import code block into current project and configuration code building block library 720 allows a developer to both import the content of selected code block, such as code block 1.2 610, into the integrated development environment, like IAE programming design application interface 500 of FIG. 5, and to a configuration code building block library, such as configuration code building block library 114 of FIG. 1. Exit 722 allows a developer to exit further view of generative AI code block selector and codebase updating system interface 600 without importing the selected code block.

FIG. 8 illustrates computing system 805. Computing system 805 is generally representative of a client device such as client device 102. Computing system 805 is representative of any system or collection of systems with which the various operational architectures, processes, scenarios, and sequences disclosed herein for implementation of a generative AI code block selector and codebase updating system may be employed. Computing system 805 may be implemented as a single apparatus, system, or device or may be implemented in a distributed manner as multiple apparatuses, systems, or devices. Computing system 805 includes, but is not limited to, processing system 825, storage system 810, software 815, communication interface system 820, and user interface system 830. Processing system 825 is operatively coupled with storage system 810, communication interface system 820, and user interface system 830. Software 815 may further include instructions, that when executed, cause the processor to launch an operation of a generative AI code block selector and codebase updating system. Code block selector 835, AI model selector engine 840, isolated code block testing environment 845, user interface 850, and communication 855 are representative of such instructions. Computing system 805 may be representative of a cloud computing device, distributed computing device, or the like.

Processing system 825 loads and executes software 815 from storage system 810. Software 815 includes and implements code block selector 835, AI model selector engine 840, isolated code block testing environment 845, user interface 850, and communication 855. When executed by processing system 825 to provide generative AI code block selection and codebase updating, software 815 directs processing system 825 to operate as described herein for at least the various processes, operational scenarios, and sequences discussed in the foregoing implementations. Computing system 805 may optionally include additional devices, features, or functionality not discussed for purposes of brevity.

Processing system 825 may comprise a microprocessor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, graphical processing units, application specific processors, and logic devices, as well as any other type of processing device, combinations, or variations thereof.

Storage system 810 may comprise any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 810 may also include computer readable communication media over which at least some of software 815 may be communicated internally or externally. Storage system 810 may be implemented as a single storage device but may also be implemented across multiple storage devices or sub-systems co-located or distributed relative to each other. Storage system 810 may comprise additional elements, such as a controller capable of communicating with processing system 825 or possibly other systems.

Software 815 (including code block selector 835, AI model selector engine 840, isolated code block testing environment 845, and user interface 850) may be implemented in program instructions and among other functions may, when executed by processing system 825, direct processing system 825 to operate as described with respect to the various operational scenarios, sequences, and processes illustrated herein. For example, software 815 may include program instructions for implementing generative AI code block selection and codebase updating.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 815 may include additional processes, programs, or components, such as operating system software, virtualization software, or other application software. Software 815 may also comprise firmware or some other form of machine-readable processing instructions executable by processing system 825.

In general, software 815 may, when loaded into processing system 825 and executed, transform a suitable apparatus, system, or device (of which computing system 805 is representative) overall from a general-purpose computing system into a special-purpose computing system customized to generative AI code block selection and codebase updating as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of control software for industrial devices in an IAE, it should be understood that the generative AI code block selection and codebase updating systems and methods described herein are not limited to such embodiments and may apply to a variety of other automation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
receiving, at a code block selector, configuration criteria via a user interface of a client device, wherein the configuration criteria comprises a quality parameter and a task;
obtaining a subset of code blocks from a code block repository storing a plurality of code blocks, wherein each code block of the subset of code blocks performs the task when executed;
selecting an artificial intelligence (AI) model of a plurality of AI models based at least on the configuration criteria, wherein the AI model is trained to analyze an execution of one or more code blocks;
identifying, using the AI model, a selected code block of the subset of code blocks that achieves the quality parameter for the task, wherein identifying the selected code block comprises:
executing each code block of the subset of code blocks in an isolated testing environment,
analyzing the execution of each code block with the AI model, and
selecting, with the AI model, one of the subset of code block based on the analyzing the execution; and
providing, via the user interface, the selected code block.

2. The method of claim 1, further comprising:
in response to identifying the selected code block, sending the selected code block to a configuration code building block library.

3. The method of claim 2, wherein sending the selected code block to the configuration code building block library further comprises:
providing a prompt to user, via the user interface, the prompt comprising a request for a confirmation to store the selected code block in the configuration code building block library, and
in response to receiving the confirmation, adding the selected code block to the configuration code building block library.

4. The method of claim 1, wherein the quality parameter of the configuration criteria comprises one of a most energy efficient execution of the task of the configuration criteria, a fastest execution of the task of the configuration criteria, a most secure execution of the task of the configuration criteria, or a combination thereof.

5. The method of claim 1, further comprising:
in response to receiving a code block from the code block repository, sanitizing, by a code block sanitizer, the code block.

6. The method of claim 1, wherein the user interface of the client device comprises an industrial control software development environment.

7. The method of claim 1, further comprising:
generating, via the user interface, a prompt to launch the code block selector.

8. The method of claim 1, further comprising:
providing, via the user interface, an interactable element wherein triggering the interactable element launches the code block selector.

9. The method of claim 1, wherein the isolated testing environment is a sandbox environment.

10. The method of claim 1, wherein selecting of the AI model of the plurality of AI models further comprises:
selecting an AI model from a tiered list of AI models, wherein each tier of the tiered list of AI models represents a subset of AI models having substantially the same degree of domain specific training data.

11. A system, comprising:
a code block repository storing a plurality of code blocks each designed to execute on a controller to perform tasks in an industrial automation environment using industrial automation devices;
an AI model library storing a plurality of AI models each trained to analyze execution of one or more code blocks in an isolated testing environment;
a code block selector, comprising:
one or more processors, and
one or more memories having instructions stored thereon that, upon execution by the one or more processors, cause the one or more processors to:
receive a configuration criteria via a user interface from a client device, wherein the configuration criteria comprises a quality parameter and a task;
obtain a subset of code blocks from the plurality of code blocks, wherein each code block of the subset of code blocks performs the task when executed;
select an AI model of the plurality of AI models based on at least the configuration criteria;
identifying, using the AI model, a selected code block of the subset of code blocks that achieves the quality parameter for the task, wherein the identifying comprises:
executing each code block of the subset of code blocks in the isolated testing environment,
analyzing the execution of each code block with the AI model, and
selecting, using the AI model, one of the subset of code blocks based on the analyzing the execution; and
provide, via the user interface, the selected code block.

12. The system of claim 11, further comprising:
a configuration code building block library, comprising a plurality of selected code blocks, wherein the instructions stored in the one or more memories of the code block selector comprise further instructions that, upon execution by the one or more processors, cause the one or more processors to:
send the selected code block to the configuration code building block library in response to the identifying the selected code block.

13. The system of claim 12, wherein the instructions to send the selected code block to the configuration code building block library comprise further instructions that, upon execution by the one or more processors, cause the one or more processors to:
prompt a user, via the user interface, requesting a confirmation to store the selected code block in the configuration code building block library, and
in response to receiving the confirmation, adding the selected code block to the configuration code building block library.

14. The system of claim 11, wherein the quality parameter of the configuration criteria comprises one of a most energy efficient execution of the task associated with the configuration criteria, a fastest execution of the task associated with the configuration criteria, a most secure execution of the task of the configuration criteria, or a combination thereof.

15. The system of claim 11, further comprising:
a code block sanitizer, comprising a node on a communication line connecting the code block repository and the code block selector, wherein, in response to receiving a code block from the code block repository, the code block sanitizer outputs a sanitized code block.

16. The system of claim 11, further comprising:
an industrial control software development environment comprising the user interface of the client device.

17. The system of claim 11, wherein the instructions to receive a configuration criteria via a user interface from a client device comprise further instructions that, upon execution by the one or more processors, cause the one or more processors to:
generate, via the user interface, a prompt to launch the generative AI code block selector and codebase updating system.

18. The system of claim 11, wherein the instructions to receive a configuration criteria via a user interface from a client device comprise further instructions that, upon execution by the one or more processors, cause the one or more processors to:
provide an interactable element in the user interface; and
in response to selection of the interactable element, launch the generative AI code block selector and codebase updating system.

19. The system of claim 11, wherein the isolated testing environment is a sandbox environment.

20. The system of claim 11, wherein the instructions to select the AI model of the plurality of AI models comprise further instructions that, upon execution by the one or more processors, cause the one or more processors to:
select the AI model from a tiered list of AI models, wherein each tier of the tiered list of AI models represents a subset of AI models having substantially the same degree of domain specific training data.
